(19) United States
(12) Patent Application Publication
(10) Pub. No.: US 2025/0389037 A1
(43) Pub. Date: Dec. 25, 2025

(54) ELECTROLYZER STRUCTURE

(71) Applicant: L'Air Liquide, Societe Anonyme pour l'Etude et l'Exploitation des Procedes Georges Claude, Paris (FR)

(72) Inventors: Denis Sirac, Grenoble (FR); Fiorent Beille, Lans-en-Vercors (FR)

(73) Assignee: L'Air Liquide, Societe Anonyme pour l'Etude et l'Exploitation des Procedes Georges Claude, Paris (FR)

(21) Appl. No.: 19/242,464

(22) Filed: Jun. 18, 2025

(30) Foreign Application Priority Data
Jun. 19, 2024 (FR) FRFR2406548

(51) Int. Cl. C25B 13/02; C25B 9/75; C25B 9/77; H01M 8/0273; H01M 8/18; H01M 8/242

(52) U.S. Cl. CPC C25B 13/02; C25B 9/75; C25B 9/77; H01M 8/0273; H01M 8/188; H01M 8/242

(57) ABSTRACT

The invention relates to a structure of an electrolyzer or redox battery, having a first frame and a second frame which are intended to be stacked in an electrolyzer or in a redox battery and are each provided with a distribution face for distributing a first electrolyte, respectively a second electrolyte, and with a bearing face.

### CROSS REFERENCE TO RELATED APPLICATIONS

This application claims the benefit of priority under 35 U.S.C. § 119 (a) and (b) to French Patent Application No. FR2406548, filed Jun. 19, 2024, the entire contents of which are incorporated herein by reference.

### BACKGROUND

The invention relates to a structure of an electrolyzer or redox battery. The invention also relates to a cell of an electrolyzer or redox battery provided with such a structure and to an electrolyzer comprising a stack of such cells.

An electrolyzer for water electrolysis constitutes an electrochemical reactor configured to subject water to an electromotive force so as to generate dioxygen and dihydrogen through water electrolysis.

This type of electrolyzer generally comprises a stack of cells each comprising two frames sandwiching a membrane, each frame enabling the diffusion of an electrolyte through a porous element.

The electrolysis reaction occurring in the cells generates heat which, for optimal operation of the electrolyzer, has to be discharged. Generally, the electrolyte, of which the water is intended to be electrolyzed, is also used as a vector for discharging the heat energy generated by the electrolysis reaction from the stack.

The cells each delimit an oxygen compartment (or anode compartment) between an anode plate and the membrane, for the recovery of dioxygen, and a hydrogen compartment (or cathode compartment) between a cathode plate and the membrane, for the recovery of dihydrogen.

The anode plate and the cathode plate can be connected to one another to form a bipolar plate.

To achieve the objectives related to the cost of hydrogen, the components of the cell are often rectangular in order to minimize material losses. Furthermore, the cells are larger and larger in order to generate more gas. In this context, it is important to ensure good sealing for the electrolyte, from the compartment to its entry into the porous element, which is essential for obtaining good performance.

### SUMMARY

The present invention aims to effectively remedy these drawbacks by proposing a structure of an electrolyzer or redox battery, comprising a first frame and a second frame which are intended to be stacked in an electrolyzer or in a redox battery and are each provided with a distribution face for distributing a first electrolyte, respectively a second electrolyte, and with a bearing face, the first frame, respectively the second frame, comprising:
an inlet manifold port passing through the frame in order to convey the first electrolyte, respectively the second electrolyte, onto the distribution face, the inlet manifold port being surrounded by a fifth sealing band provided on the bearing face;
an outlet manifold port passing through the frame in order to discharge the first electrolyte, respectively the second electrolyte, from the distribution face, the outlet manifold port being surrounded by a sixth sealing band provided on the bearing face;
a central housing, notably for receiving a porous element, surrounded by a seventh sealing band provided on the bearing face;
a first slot formed through the frame, for the passage of the second electrolyte, respectively of the first electrolyte, in a direction of a thickness of the frame and in a first direction of circulation, the first slot being surrounded by a first sealing band provided on the distribution face and being surrounded by a third sealing band provided on the bearing face;
a second slot formed through the frame, for the passage of the second electrolyte, respectively of the first electrolyte, in the direction of the thickness of the frame and in a second direction of circulation opposite the first direction of circulation, the second slot being surrounded by a second sealing band provided on the distribution face and being surrounded by a fourth sealing band provided on the bearing face;
a distribution cavity provided on the distribution face, for distributing the first electrolyte, respectively the second electrolyte, from the inlet manifold port to the central housing;
a discharge cavity provided on the distribution face, for discharging the first electrolyte, respectively the second electrolyte, from the central housing to the outlet manifold port, the distribution cavity, and notably the discharge cavity, comprising a central distribution bowl fluidically connected, by a first end, to a plurality of first channels formed by relief elements and hollows and, by a second end, to a plurality of second channels formed by relief elements and hollows;
   the first and second frames being stacked such that the bearing face of the first frame is oriented toward the bearing face of the second frame and being stacked such that the inlet manifold port of the first frame is aligned with the second slot of the second frame and such that the outlet manifold port of the first frame is aligned with the first slot of the second frame, the structure being configured such that a portion, notably a longitudinal portion, of the seventh sealing band of the second frame is aligned with at least a portion of the second channels of the first frame in order to provide a transfer of load on the relief elements of the second channels of the first frame when the frames are stacked.

Such a transfer of load, when the structure is mounted clamped in a stack of cells of an electrolyzer or redox battery, makes it possible to ensure sealing at high pressure, for example a pressure of at least 30 barg, while ensuring that electrolyte is supplied to and distributed in the cells in an optimal manner. Such sealing of the cells can thus be ensured with respect to external leaks but also between the compartments of the stack.

According to one embodiment, the structure is configured such that there is a plane orthogonal to the plane in which the first frame extends, intersecting one of the sealing bands of one of the faces of the first frame, notably passing through an apex, said plane passing through a first bead provided on the other of the faces of the first frame, said plane passing through a second bead provided on one of the faces of the second frame and said plane passing through a third bead provided on the other of the faces of the second frame.

Such an arrangement makes it possible to improve the transfer of load with respect to the sealing bands, and therefore to improve the sealing of such a structure when it is mounted in an electrolyzer or a redox battery.

According to one embodiment, the structure comprises at least one sealing film interposed between the first frame and the second frame and intended to be clamped by the first frame and by the second frame when they are stacked.

Such an arrangement makes it possible, when the frames are stacked, to implement complete sealing while enabling a significant reduction in the thickness of the frames by dispensing with grooves for receiving seals, the sealing being ensured by the sealing bands.

According to one embodiment, the sealing film comprises a polytetrafluoroethylene (PTFE) film.

According to one embodiment, the sealing film comprises Teflon.

According to one embodiment, the sealing film is between 100 and 300 microns thick.

According to one embodiment, the sealing film is configured to extend over substantially the entire surface of the first frame and/or of the second frame and configured to form the sealing of the structure with respect to an electrolyte.

According to one embodiment, the first frame does not have a groove for receiving an attached seal.

According to one embodiment, the second frame does not have a groove for receiving an attached seal.

Such a configuration makes it possible to significantly reduce the thickness of the frames, and therefore of the cells, thus enabling better performance of a battery or of an electrolyzer equipped with such frames.

According to one embodiment, the structure is configured such that the sealing film is clamped on one of its sides by one of the sealing bands and on another of its sides by another of the sealing bands, when the frames are stacked.

According to one embodiment, the structure is configured such that the sealing film is clamped on one of its sides by one of the beads and on another of its sides by another of the beads, when the frames are stacked.

According to one embodiment, at least one of the sealing bands is formed in one piece with the frame.

According to one embodiment, each sealing band is formed in one piece with the frame.

According to one embodiment, the first, second and third beads each comprise a portion in relief, notably projecting with respect to a planar surface of the first frame or of the second frame.

According to one embodiment, at least one of the first bead, of the second bead and of the third bead forms a portion of one of the sealing bands, notably a ridge of one of the sealing bands.

According to one embodiment, at least one of the first bead, of the second bead and of the third bead forms a relief element of at least one of the plurality of first channels or second channels.

According to one embodiment, at least one of the first bead, of the second bead and of the third bead forms a thickening of at least one of the relief elements forming the plurality of first channels or second channels.

According to one embodiment, the first and second frames are stacked such that the first slot of the first frame is aligned, notably edge to edge, with the inlet manifold port of the second frame and such that the second slot of the first frame is aligned, notably edge to edge, with the outlet manifold port of the second frame.

According to one embodiment, the first and second frames are stacked such that the central housing of the first frame is aligned, notably edge to edge, with the central housing of the second frame.

According to one embodiment, the first frame and/or the second frame is composed of a polymer.

According to one embodiment, the central housing has a hole passing through the frame.

According to one embodiment, the structure is configured such that a portion, notably a longitudinal portion, of the second sealing band of the second frame is aligned with at least a portion of the first channels of the first frame in order to provide a transfer of load on the relief elements of the first channels when the frames are stacked.

According to one embodiment, the structure is configured such that there is a plane orthogonal to the plane in which the frames extend, intersecting at least one of the second channels of the first frame in the transverse direction and intersecting a longitudinal portion of the seventh sealing band of the first frame, notably intersecting a longitudinal portion of the seventh sealing band of the second frame.

According to one embodiment, the structure is configured such that there is a plane orthogonal to the plane in which the frames extend, intersecting at least one of the first channels of the first frame in the transverse direction and intersecting a longitudinal portion of the second sealing band of the second frame and notably intersecting a longitudinal portion of the fourth sealing band of the second frame.

According to one embodiment, the plurality of first channels is configured to form chicanes such that the first electrolyte, respectively the second electrolyte, flows by forming meanders.

According to one embodiment, the plurality of second channels forms a comb such that the first electrolyte flows by forming a homogeneous jet.

According to one embodiment, each of the first channels is configured to open out into the inlet manifold port to fluidically connect the inlet manifold port and the central distribution bowl.

According to one embodiment, each of the second channels is configured to open out into the outlet manifold port to fluidically connect the central distribution bowl and the central housing.

According to one embodiment, the first frame, respectively the second frame, comprises an eighth sealing band provided on the distribution face, being configured to contain the first electrolyte, respectively the second electrolyte, in a central distribution zone with respect to a peripheral border of the frame, when they are stacked in an electrolyzer or in a redox battery.

According to one embodiment, the central distribution zone encompasses both the inlet manifold port, the distribution cavity, the discharge cavity, the central housing and the outlet manifold port.

According to one embodiment, at least one of the first and second sealing bands is provided with ridges, which are notably parallel to one another, projecting with respect to the distribution face and/or at least one of the third, fourth, fifth, sixth and seventh sealing bands is provided with a plurality of ridges, which are notably parallel to one another, projecting with respect to the bearing face.

According to one embodiment, the ridges are machined from the same material as the first frame and/or as the second frame.

According to one embodiment, the ridges are configured to enable, when the frames are stacked, a deformation of the sealing film.

Such ridges enable a localized deformation of the sealing film, thus enabling very good sealing with little pressure load.

According to one embodiment, the eighth sealing band is provided with ridges, which are notably parallel to one another, projecting with respect to the distribution face.

According to one embodiment, at least one of the sealing bands is configured such that one of its ridges is at a lower level than another of its ridges, notably disposed at the periphery of the band.

According to one embodiment, at least one of the sealing bands is configured such that one of its ridges has a profile distinct from another of its ridges.

According to one embodiment, an apex of at least one ridge of the plurality of ridges has a height of between 20 and 200 microns.

Such ridges make it possible to significantly improve the sealing with respect to high pressures.

According to one embodiment, at least one of the sealing bands, notably each sealing band, comprises a strip in relief with respect to the plane of the frame, notably being continuous.

According to one embodiment, the relief elements forming the plurality of first channels or second channels comprise a thickening disposed facing at least one of the ridges of the bearing face.

According to one embodiment, each frame is configured such that there is a plane orthogonal to the plane in which the frame extends, intersecting the thickening of a relief element forming the plurality of first channels or second channels and an apex of one of the ridges provided on the bearing face.

According to one embodiment, the distribution cavity is configured such that the first electrolyte, respectively the second electrolyte, travels successively from the inlet manifold port to the central housing through: the plurality of first channels, the central distribution bowl and the plurality of second channels.

According to one embodiment, the first frame and the second frame are each in the form of the same mechanical component and are intended to be stacked such that the first frame is rotated by 180° with respect to the second frame.

The invention also relates to a structure of an electrolyzer or redox battery, comprising a first frame and a second frame which are intended to be stacked in an electrolyzer or in a redox battery and are each provided with a distribution face for distributing a first electrolyte, respectively a second electrolyte, and with a bearing face, the first frame, respectively the second frame, comprising:
an inlet manifold port passing through the frame in order to convey the first electrolyte, respectively the second electrolyte, onto the distribution face, the inlet manifold port being surrounded by a fifth sealing band provided on the bearing face;
an outlet manifold port passing through the frame in order to discharge the first electrolyte, respectively the second electrolyte, from the distribution face, the outlet manifold port being surrounded by a sixth sealing band provided on the bearing face;
a central housing, notably for receiving a porous element, surrounded by a seventh sealing band provided on the bearing face;
a first slot formed through the frame, for the passage of the second electrolyte, respectively of the first electrolyte, in a direction of a thickness of the frame and in a first direction of circulation, the first slot being surrounded by a first sealing band provided on the distribution face and being surrounded by a third sealing band provided on the bearing face;
a second slot formed through the frame, for the passage of the second electrolyte, respectively of the first electrolyte, in the direction of the thickness of the frame and in a second direction of circulation opposite the first direction of circulation, the second slot being surrounded by a second sealing band provided on the distribution face and being surrounded by a fourth sealing band provided on the bearing face;
a distribution cavity provided on the distribution face, for distributing the first electrolyte, respectively the second electrolyte, from the inlet manifold port to the central housing;
a discharge cavity provided on the distribution face, for discharging the first electrolyte, respectively the second electrolyte, from the central housing to the outlet manifold port, the distribution cavity, and notably the discharge cavity, comprising a central distribution bowl fluidically connected, by a first end, to a plurality of first channels formed by relief elements and hollows and, by a second end, to a plurality of second channels formed by relief elements and hollows;
   the first and second frames being stacked such that the bearing face of the first frame is oriented toward the bearing face of the second frame and being stacked such that the inlet manifold port of the first frame is aligned with the second slot of the second frame and such that the outlet manifold port of the first frame is aligned with the first slot of the second frame, the structure being configured such that there is a plane orthogonal to the plane in which the first frame extends, intersecting one of the sealing bands of one of the faces of the first frame, notably passing through an apex, said plane passing through a first bead provided on the other of the faces of the first frame, said plane passing through a second bead provided on one of the faces of the second frame and said plane passing through a third bead provided on the other of the faces of the second frame.

The invention also relates to a cell of an electrolyzer or redox battery, comprising at least one structure as described above, a membrane and two porous elements, the cell being configured such that the membrane is sandwiched between the two frames, each of the porous elements being disposed respectively in the central housing of each frame, the cell being configured such that each porous element is passed through, the one by the first electrolyte, and the other by the second electrolyte.

The invention also relates to an electrolyzer comprising a stack of a plurality of cells as described above and at least one bipolar plate sandwiched between two cells.

According to one embodiment, the bipolar plate is metallic.

According to one embodiment, the electrolyzer is an electrolyzer of the PEM type or alkaline type, such as an electrolyzer of the AEM type, notably for water electrolysis.

According to one embodiment, the electrolyzer comprises a sealing film interposed between the bipolar plate and the cell, on each side of the bipolar plate.

According to one embodiment, the electrolyzer comprises a first collector plate at a first end of the stack and a second collector plate at a second end of the stack, for collecting an electrical current.

The invention lastly relates to a redox battery comprising a stack of a plurality of cells as described above.

The invention may also relate to any alternative device or method comprising any combination of the features above or below within the scope of the claims.

### BRIEF DESCRIPTION OF THE DRAWINGS

The invention will be understood more clearly from reading the following description and from studying the accompanying figures. These figures are given only by way of illustration and do not in any way limit the invention.

FIG. 1 shows a schematic view illustrating one of the faces of a frame of a structure according to the invention;

FIG. 2 shows a schematic view illustrating the other of the faces of a frame of a structure according to the invention;

FIG. 3 shows a schematic view in transparency of a structure according to the invention;

FIG. 4 shows a schematic view in section of an electrolyzer according to the invention;

FIG. 5 shows a schematic and partial view of a detail of the section in [FIG. 4];

FIG. 6 shows a schematic and partial view in section of a detail of a structure according to the invention; and

FIG. 7 shows a schematic and partial view in section of a detail of a structure according to the invention.

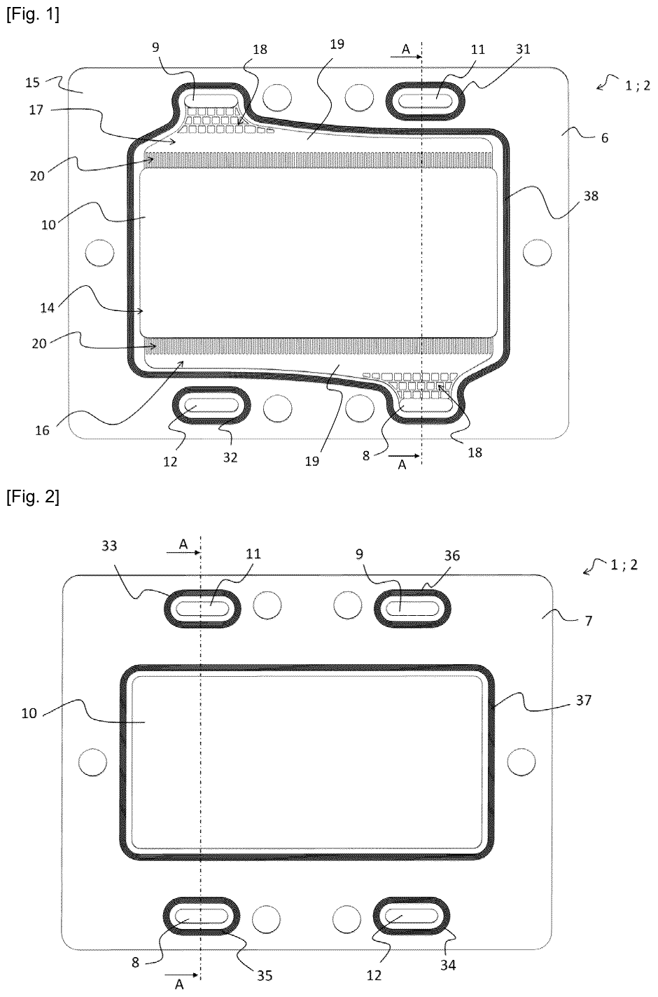

FIG. 1 shows the distribution face 6 of a first frame 1, respectively of a second frame 2, intended to be stacked in an electrolyzer 50 or in a redox battery. [FIG. 2] shows the bearing face 7 of the first frame 1, respectively of the second frame 2, in [FIG. 1].

### DETAILED DESCRIPTION OF PREFERRED EMBODIMENTS

A structure of an electrolyzer 50 or redox battery comprises a first frame 1 and a second frame 2 as illustrated in [FIG. 1] and in [FIG. 2] and intended to be stacked in an electrolyzer 50 or in a redox battery. The first frame 1 and second frame 2 are each provided with a distribution face 6 for distributing a first electrolyte, respectively a second electrolyte, and with a bearing face 7.

The first frame 1 and the second frame 2 each comprise:
an inlet manifold port 8; 9 passing through the frame in order to convey the first electrolyte, respectively the second electrolyte, onto the distribution face 6, the inlet manifold port 8; 9 being surrounded by a fifth sealing band 35; 36 provided on the bearing face 7.
an outlet manifold port 9; 8 passing through the frame in order to discharge the first electrolyte, respectively the second electrolyte, from the distribution face 6, the outlet manifold port 9; 8 being surrounded by a sixth sealing band 36; 35 provided on the bearing face 7.
a central housing 10, notably for receiving a porous element 3, surrounded by a seventh sealing band 37 provided on the bearing face 7.
a first slot 11; 12 formed through the frame, for the passage of the second electrolyte, respectively of the first electrolyte, in a direction of a thickness of the frame and in a first direction of circulation, the first slot 11; 12 being surrounded by a first sealing band 31; 32 provided on the distribution face 6 and being surrounded by a third sealing band 33; 34 provided on the bearing face 7.
a second slot 12; 11 formed through the frame, for the passage of the second electrolyte, respectively of the first electrolyte, in the direction of the thickness of the frame 1 and in a second direction of circulation opposite the first direction of circulation, the second slot 12; 11 being surrounded by a second sealing band 32; 31 provided on the distribution face 6 and being surrounded by a fourth sealing band 34; 33 provided on the bearing face 7.
a distribution cavity 16; 17 provided on the distribution face 6, for distributing the first electrolyte, respectively the second electrolyte, from the inlet manifold port 8; 9 to the central housing 10.
a discharge cavity 17; 16 provided on the distribution face 6, for discharging the first electrolyte, respectively the second electrolyte, from the central housing 10 to the outlet manifold port 9; 8, the distribution cavity 16; 17, and notably the discharge cavity 17; 16, comprising a central distribution bowl 19 fluidically connected, by a first end, to a plurality of first channels 18 formed by relief elements and hollows and, by a second end, to a plurality of second channels 20 formed by relief elements and hollows.

The structure is configured such that when the first frame 1 and second frame 2 are stacked:
the bearing face 7 of the first frame 1 is oriented toward the bearing face 7 of the second frame 2;
the inlet manifold port 8 of the first frame 1 is aligned with the second slot 11 of the second frame 2;
the outlet manifold port 9 of the first frame 1 is aligned with the first slot 12 of the second frame 2;
a portion, notably a longitudinal portion, of the seventh sealing band 37 of the second frame 2 is aligned with at least a portion of the second channels 20 of the first frame 1 in order to provide a transfer of load on the relief elements of the second channels 20 of the first frame 1 when the first frame 1 and second frame 2 are stacked, notably mounted clamped;
the first slot 11 of the first frame 1 is aligned, notably edge to edge, with the inlet manifold port 8 of the second frame 2;
the second slot 12 of the first frame 1 is aligned, notably edge to edge, with the outlet manifold port 9 of the second frame 2;
the central housing of the first frame 1 is aligned, notably edge to edge, with the central housing of the second frame 2.

The alignment is considered when the first frame 1 and second frame 2 are stacked on one another with or without interposition of one or more intermediate components between them. Such an alignment notably allows the first electrolyte and the second electrolyte to circulate through the stack by passing through the inlet manifold port 8 or outlet manifold port 9 of each frame of the stack in a direction of an axis intersecting both frames of the stack.

The structure is configured such that a portion, notably a longitudinal portion, of the second sealing band 33 of the second frame 2 is aligned with at least a portion of the first channels 18 of the first frame 1 in order to provide a transfer of load on the relief elements of the first channels 18 when the frames 1, 2 are stacked, notably mounted clamped.

The structure is configured such that there is a plane orthogonal to the plane in which the frames extend, intersecting at least one of the second channels 20 of the first frame 1 in the transverse direction and intersecting a longitudinal portion of the seventh sealing band 37 of the first frame 1, notably intersecting a longitudinal portion of the seventh sealing band 37 of the second frame 2.

The structure comprises at least one sealing film 51 interposed between the first frame 1 and the second frame 2 and intended to be clamped by the first frame 1 and by the second frame 2 when they are stacked.

The distribution face 6 of each frame 1, 2 is intended to clamp a sealing film 51 when the frames 1, 2 are stacked.

The bearing face 7 of each frame 1, 2 is intended to clamp a sealing film 51 when the frames 1, 2 are stacked.

The structure is configured such that there is a plane orthogonal to the plane in which the frames extend, intersecting at least one of the first channels 18 of the first frame 1 in the transverse direction and intersecting a longitudinal portion of the second sealing band 33 of the second frame 2 and notably intersecting a longitudinal portion of the fourth sealing band 31 of the second frame 2.

The first frame 1, respectively the second frame 2, comprises an eighth sealing band 38 provided on the distribution face 6, being configured to contain the first electrolyte, respectively the second electrolyte, in a central distribution zone 14 with respect to a peripheral border 15 of the frame, when they are stacked in an electrolyzer 50 or in a redox battery.

The central distribution zone 14 encompasses both the inlet manifold port 8; 9, the distribution cavity 16; 17, the discharge cavity 17; 16, the central housing 10 and the outlet manifold port 9; 8.

At least one of the first 31; 32, second 32; 31 and eighth 38 sealing bands is provided with ridges, which are notably parallel to one another, projecting with respect to the distribution face 6 and/or at least one of the third 33; 34, fourth 34; 33, fifth 35; 36, sixth 36; 35 and seventh 37 sealing bands is provided with a plurality of ridges, which are notably parallel to one another, projecting with respect to the bearing face 7.

At least one of the sealing bands 31-38 is configured such that one of its ridges is at a lower level than another of its ridges, notably disposed at the periphery of the band.

At least one of the sealing bands 31-38 is configured such that one of its ridges has a profile distinct from another of its ridges.

An apex of at least one ridge of the plurality of ridges has a height of between 20 and 200 microns. Such ridges make it possible to improve the sealing with respect to high pressures.

At least one of the sealing bands 31-38, notably each sealing band 31-38, comprises a strip in relief with respect to the plane of the frame, notably being continuous.

The relief elements forming the plurality of first channels 18 or second channels 20 comprise a thickening disposed facing at least one of the ridges of the bearing face 7.

Each frame is configured such that there is a plane orthogonal to the plane in which the frame extends, intersecting the thickening of a relief element forming the plurality of first channels 18 or second channels 20 and an apex of one of the ridges provided on the bearing face 7.

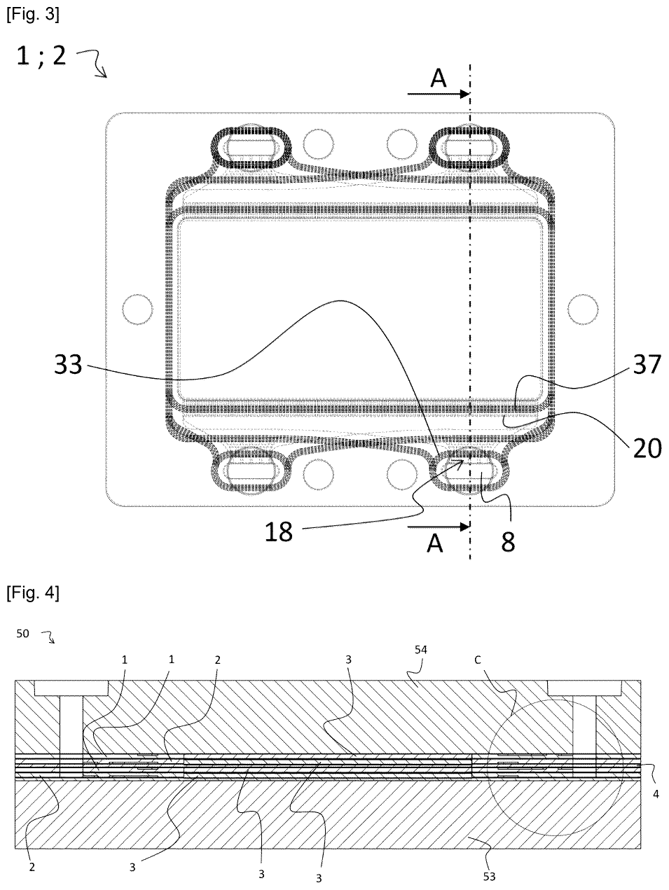

FIG. 3 schematically shows, in transparency, the first frame 1 and the second frame 2 of a structure as described above. As can be seen in transparency, the first frame 1 and second frame 2 are stacked and aligned as described above. With such a configuration of the frames of the structure:
a portion, notably a longitudinal portion, of the seventh sealing band 37 of the second frame 2 is aligned with at least a portion of the second channels 20 of the first frame 1 in order to provide a transfer of load on the relief elements of the second channels 20 of the first frame 1 when the first frame 1 and second frame 2 are stacked, notably mounted clamped; and
a portion, notably a longitudinal portion, of the second sealing band 33 of the second frame 2 is aligned with at least a portion of the first channels 18 of the first frame 1 in order to provide a transfer of load on the relief elements of the first channels 18 when the frames 1, 2 are stacked, notably mounted clamped.

The first frame 1 and the second frame 2 are each in the form of the same mechanical component and are intended to be stacked such that the first frame 1 is rotated by 180° with respect to the second frame 2.

FIG. 4 shows an electrolyzer 50 comprising a stack of a plurality of cells 40 and at least one bipolar plate 4 sandwiched between two cells 40. Each cell 40 comprises at least one structure as described above, a membrane 52 and two porous elements 3, the cell 40 being configured such that the membrane 52 is sandwiched between the two frames 1; 2, each of the porous elements 3 being disposed respectively in the central housing 10 of each frame 1, the cell 40 being configured such that each porous element 3 is passed through, the one by the first electrolyte, and the other by the second electrolyte.

FIG. 4 is a view in section along the axis A-A of the structure in [FIG. 3].

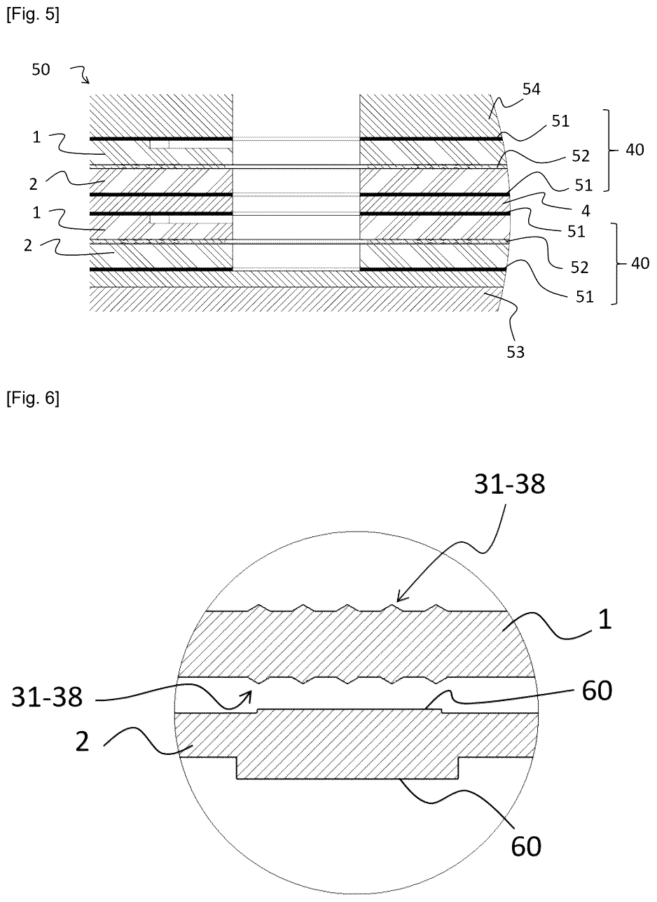

FIG. 5 shows a detail of the section in [FIG. 4], in the region of the circle C.

As can be seen in [FIG. 5], a sealing film 51 is interposed between the bipolar plate 4 and the cell 40, on each side of the bipolar plate 4.

The electrolyzer 50 comprises a first collector plate 53 at a first end of the stack and a second collector plate 54 at a second end of the stack, for collecting an electrical current.

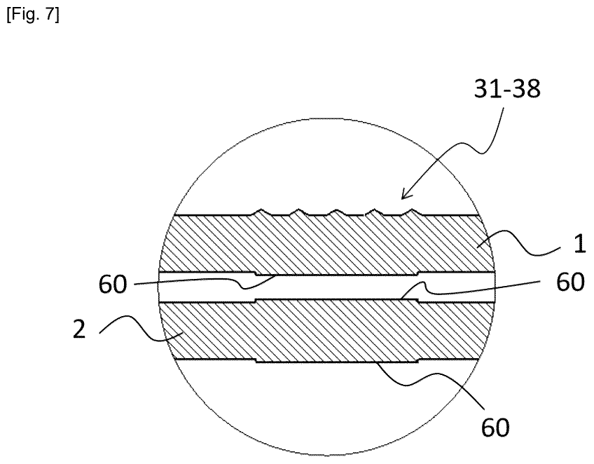

FIG. 6 and [FIG. 7] depict embodiments of a structure as described above.

FIG. 6 is a section along a plane orthogonal to the plane in which the first frame 1 extends. As can be seen in [FIG. 6], the orthogonal plane passes through one of the sealing bands 31-38 of one of the faces of the first frame 1. This orthogonal plane also passes through a first bead provided on the other of the faces of the first frame 1. In the example in [FIG. 6], the first bead belongs to another of the sealing bands 31-38 of the other of the faces of the first frame 1.

This orthogonal plane also passes through a second bead 60 provided on one of the faces of the second frame 2 and through a third bead 60 provided on the other of the faces of the second frame 2.

FIG. 7 is a section along a plane orthogonal to the plane in which the first frame 1 extends. As can be seen in [FIG. 7], the orthogonal plane passes through one of the sealing bands 31-38 of one of the faces of the first frame 1. This orthogonal plane also passes through a first bead 60 provided on the other of the faces of the first frame 1.

This orthogonal plane also passes through a second bead 60 provided on one of the faces of the second frame 2 and through a third bead 60 provided on the other of the faces of the second frame 2.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A structure of an electrolyze or redox battery, comprising a first frame and a second frame which are configured to be stacked in an electrolyzer or in a redox battery and are each provided with a distribution face for distributing a first electrolyte, respectively a second electrolyte, and with a bearing face, the first frame, respectively the second frame, comprising:
an inlet manifold port passing through the frame in order to convey the first electrolyte, respectively the second electrolyte, onto the distribution face, the inlet manifold port being surrounded by a fifth sealing band provided on the bearing face;
an outlet manifold port passing through the frame in order to discharge the first electrolyte, respectively the second electrolyte, from the distribution face, the outlet manifold port being surrounded by a sixth sealing band provided on the bearing face;
a central housing configured to receive a porous element, surrounded by a seventh sealing band provided on the bearing face;
a first slot formed through the frame, configured to provide the passage of the second electrolyte, respectively of the first electrolyte, in a direction of a thickness of the frame and in a first direction of circulation, the first slot being surrounded by a first sealing band provided on the distribution face and being surrounded by a third sealing band provided on the bearing face;
a second slot formed through the frame, for the passage of the second electrolyte, respectively of the first electrolyte, in the direction of the thickness of the frame and in a second direction of circulation opposite the first direction of circulation, the second slot being surrounded by a second sealing band provided on the distribution face and being surrounded by a fourth sealing band provided on the bearing face;
a distribution cavity provided on the distribution face, for distributing the first electrolyte, respectively the second electrolyte, from the inlet manifold port to the central housing;
a discharge cavity provided on the distribution face, for discharging the first electrolyte, respectively the second electrolyte, from the central housing to the outlet manifold port, the distribution cavity, and the discharge cavity, comprising a central distribution bowl fluidically connected, by a first end, to a plurality of first channels formed by relief elements and hollows and, by a second end, to a plurality of second channels formed by relief elements and hollows;
the first and second frames being stacked such that the bearing face of the first frame is oriented toward the bearing face of the second frame and being stacked such that the inlet manifold port of the first frame is aligned with the second slot of the second frame and such that the outlet manifold port of the first frame is aligned with the first slot of the second frame, the structure being configured such that a longitudinal portion of the seventh sealing band of the second frame is aligned with at least a portion of the second channels of the first frame in order to provide a transfer of load on the relief elements of the second channels of the first frame when the frames are stacked.

2. The structure as claimed in claim 1, configured such that there is a plane orthogonal to the plane in which the first frame extends, intersecting one of the sealing bands of one of the faces of the first frame, thereby passing through an apex, said plane passing through a first bead provided on the other of the faces of the first frame, said plane passing through a second bead provided on one of the faces of the second frame and said plane passing through a third bead provided on the other of the faces of the second frame.

3. The structure as claimed in claim 1, comprising at least one sealing film interposed between the first frame and the second frame and configured to be clamped by the first frame and by the second frame when they are stacked.

4. The structure as claimed in claim 1, configured such that a longitudinal portion of the second sealing band of the second frame is aligned with at least a portion of the first channels of the first frame in order to provide a transfer of load on the relief elements of the first channels when the frames are stacked.

5. The structure as claimed in claim 1, configured such that there is a plane orthogonal to the plane in which the frames extend, intersecting at least one of the second channels of the first frame in the transverse direction and intersecting a longitudinal portion of the seventh sealing band of the first frame, thereby intersecting a longitudinal portion of the seventh sealing band of the second frame.

6. The structure as claimed in claim 1, configured such that there is a plane orthogonal to the plane in which the frames extend, intersecting at least one of the first channels of the first frame in the transverse direction and intersecting a longitudinal portion of the second sealing band of the second frame and thereby intersecting a longitudinal portion of the fourth sealing band of the second frame.

7. The structure as claimed in claim 1, the plurality of first channels being configured to form chicanes such that the first electrolyte, respectively the second electrolyte, flows by forming meanders.

8. The structure as claimed in claim 1, the plurality of second channels forming a comb such that the first electrolyte flows by forming a homogeneous jet.

9. The structure as claimed in claim 1, at least one of the first and second sealing bands being provided with ridges, which are parallel to one another, projecting with respect to the distribution face and/or at least one of the third, fourth, fifth, sixth and seventh sealing bands being provided with a plurality of ridges, which are parallel to one another, projecting with respect to the bearing face.

10. A cell of an electrolyzer or redox battery, comprising at least one structure as claimed in claim 1, a membrane and two porous elements, the cell being configured such that the membrane is sandwiched between the two frames, each of the porous elements being disposed respectively in the central housing of each frame, the cell being configured such that each porous element is passed through, the one by the first electrolyte, and the other by the second electrolyte.

11. An electrolyzer comprising a stack of a plurality of cells as claimed in claim 10 and at least one bipolar plate sandwiched between two cells.
